(19) United States
(12) Patent Application Publication
(10) Pub. No.: US 2026/0142437 A1
(43) Pub. Date: May 21, 2026

(54) LASER SYSTEM AND LASER STABILIZATION METHOD

(71) Applicant: KOREA ADVANCED INSTITUTE OF SCIENCE AND TECHNOLOGY, Daejeon (KR)

(72) Inventors: Jungwon KIM, Daejeon (KR); Igju JEON, Daejeon (KR)

(21) Appl. No.: 19/317,596

(22) Filed: Sep. 3, 2025

(30) Foreign Application Priority Data
Sep. 11, 2024 (KR) 10-2024-0123922
Apr. 15, 2025 (KR) 10-2025-0048584
Sep. 3, 2025 (KR) 10-2025-0125040

(51) Int. Cl. H01S 3/137; H01S 3/13

(52) U.S. Cl. CPC H01S 3/137; H01S 3/1305

(57) ABSTRACT

A laser system comprises a laser; an interferometer-type length reference module in the form of an interferometer including a delay line, the length reference module and being configured to receive an optical signal including output of the laser and output an interference signal; and a dual stabilization module configured to stabilize the frequency of the laser to the delay line based on the interference signal and to stabilize the delay line to an optical atomic reference.

### CROSS-REFERENCE TO RELATED APPLICATIONS

This application claims priority to and the benefit of Korean Patent Application No. 10-2024-0123922 filed on Sep. 11, 2024, Korean Patent Application No. 10-2025-0048584 filed on Apr. 15, 2025, and Korean Patent Application No. 10-2025-0125040 filed on Sep. 3, 2025, the entire contents of which are incorporated herein by reference.

### BACKGROUND

### (a) Field

The present disclosure relates to a laser stabilization technique.

### (b) Description of the Related Art

Ultra-stable lasers are essential in many fields that require highly stable frequency references, such as optical lattice clocks, gravitational wave detection, and precision spectroscopy. Additionally, highly stable lasers may be used to generate highly stable microwaves through optical frequency division, which may enhance the performance of a wide range of microwave photonic applications, including radio astronomy and radar systems. In addition, the demand for smaller, more robust, and portable ultra-stable laser systems continue to grow.

Because free-oscillating lasers have poor frequency noise performance, laser frequency stabilization with respect to an optical reference is required. A Fabry-Perot resonator or an optical fiber delay line with excellent length stability may be used as the optical reference. Although lasers stabilized to a length reference may have excellent short-term stability, they suffer from degradation in long-term stability due to length drift caused by temperature changes.

On the other hand, optical atomic references provide highly accurate and stable over the long term, and therefore both length references and optical atomic references are sometimes combined to improve both short-term and long-term stability of the laser frequency. In general, a method for stabilizing the laser to a length reference and comparing the laser frequency with an optical atomic reference may be used to stabilize the laser. However, stabilizing a single laser frequency to two references requires a complex arrangement and an additional frequency modulator, thereby increasing the system complexity. Therefore, a laser that simultaneously provides excellent short-term and long-term stability remains challenging.

### SUMMARY

The present disclosure provides a laser system and a laser stabilization method. A laser system according to some embodiments includes a laser, an interferometer-type length reference module including a delay line, the length reference module being configured to receive an optical signal including output of the laser and output an interference signal; and a dual stabilization module configured to stabilize a frequency of the laser to the delay line based on the interference signal and to stabilize the delay line to an optical atomic reference.

The optical atomic reference may include an optical atomic clock.

The length reference module may be configured to: receive an optical signal in which a reference optical signal stabilized to the optical atomic clock and a target optical signal output from the laser are combined; and output the interference signal generated by interference between two optical signals that have passed through a reference path and a delay path including the delay line. The dual stabilization module may be configured to: stabilize the delay line using a first interference signal corresponding to a wavelength of the reference optical signal in the interference signal, and stabilize the frequency of the laser using a second interference signal corresponding to a wavelength of the target optical signal in the interference signal.

The optical atomic reference may include an atomic vapor cell.

The length reference module may be configured to: receive an optical signal output from the laser; and output the interference signal generated by interference between two optical signals that have passed through a reference path and a delay path including the delay line. Thea dual stabilization module may be configured to: stabilize the frequency of the laser using the interference signal; and stabilize the delay line using an optical signal that is output from the laser, incident on the atomic vapor cell, and passed through the atomic vapor cell.

The length reference module may be configured in a Michelson interferometer type or a Mach-Zehnder interferometer type.

A laser system according to some embodiments includes a length reference module configured to receive an optical signal in which a reference optical signal stabilized to an optical atomic reference and at least one target optical signal output from at least one target laser to be stabilized are combined, and output an interference signal generated by interference between two optical signals that have passed through a reference path and a delay path including a delay line; a wavelength divider configured to separate a first interference signal corresponding to a wavelength of the reference optical signal and at least one second interference signal corresponding to a wavelength of the at least one target optical signal in the interference signal; a first servo system configured to generate a first feedback signal for compensating fluctuation of the delay line with respect to the optical atomic reference based on a first error signal obtained through photodetection for the first interference signal, and transmit the first feedback signal to the length reference module; and a second servo system configured to generate a second feedback signal for compensating frequency fluctuation of the corresponding target laser with respect to the delay line based on a second error signal obtained through photodetection for the second interference signal, and transmit the second feedback signal to the corresponding target laser.

The length reference module may include a delay-line tuner configured to adjust a length of the delay line or perform frequency modulation based on the first feedback signal.

The reference optical signal and the at least one target optical signal may be signals of different wavelengths.

The target laser may include a continuous-wave laser or a pulsed laser outputting an optical frequency comb.

The target optical signal may include a single-wavelength optical signal output from the continuous-wave laser, one frequency mode filtered from the optical frequency comb, or two frequency modes filtered from the optical frequency comb.

The optical atomic reference may include an optical atomic clock.

A laser system according to some embodiments includes a length reference module configured to receive an optical signal output from a laser and output an interference signal generated by interference between two optical signals that have passed through a reference path and a delay path including a delay line; a first servo system configured to generate a first feedback signal for compensating frequency fluctuation of the laser with respect to the delay line based on a first error signal obtained through photodetection for the interference signal, and transmit the first feedback signal to the laser; an atomic vapor cell through which the optical signal output from the laser passes; and a second servo system configured to generate a second feedback signal for compensating fluctuation of the delay line with respect to the atomic vapor cell based on a second error signal obtained through photodetection for the optical signal that has passed through the atomic vapor cell, and transmit the second feedback signal to the length reference module.

The laser system may further include a frequency multiplier configured to multiply a frequency of the optical signal output from the laser to match a frequency of the atomic vapor cell, and emit the frequency-multiplied optical signal into the atomic vapor cell.

The length reference module may include a delay-line tuner configured to adjust a length of the delay line or perform frequency modulation based on the first feedback signal.

According to some embodiments, by stabilizing the length reference to the optical atomic reference and stabilizing the laser frequency to the stabilized length reference, a laser system having excellent and accurate short-term and long-term stability may be realized.

According to some embodiments, the delay line may be implemented with all-fiber, providing excellent short-term and long-term stability for the laser frequency, allowing alignment-free operation and stable use even in environments outside the laboratory.

According to some embodiments, since there is no restriction on the type of optical fiber required for the laser stabilization apparatus, the optimal optical fiber may be selected based on conditions such as cost and performance, thereby improving the price competitiveness of the laser stabilization apparatus while increasing design flexibility.

According to some embodiments, since only a few passive optical components are required for frequency stabilization, the setup is simple and compact, which is advantageous for miniaturization and packaging. In particular, since all internal components operate passively during packaging, no additional thermal management is required, a sealed enclosure made of a material with low thermal conductivity may be used, and an optical fiber spool may also be miniaturized.

According to some embodiments, the lasers to be stabilized may be independently stabilized on the delay line by distinguishing them in the wavelength domain based on the wide bandwidth of the delay line.

According to some embodiments, the optical frequency comb may be directly stabilized using a single frequency mode filtered from the optical frequency comb without requiring stabilization of the optical frequency comb through the continuous-wave laser.

### BRIEF DESCRIPTION OF THE DRAWINGS

FIG. 1 conceptually illustrates a laser system of the present disclosure.

FIGS. 2 to 4 each illustrate a laser system according to an embodiment.

FIG. 5 illustrates laser frequency stability stabilized by the laser system according to an embodiment.

FIG. 6 illustrates a laser system according to another embodiment.

FIG. 7 illustrates laser frequency stability stabilized by the laser system according to another embodiment.

FIG. 8 illustrates a length reference module in the form of a Mach-Zehnder interferometer according to an embodiment.

### DETAILED DESCRIPTION OF THE EMBODIMENTS

In the following detailed description, only certain embodiments of the present disclosure have been shown and described, simply by way of illustration. As those skilled in the art would realize, the described embodiments may be modified in various different ways, all without departing from the spirit or scope of the present invention. The drawings and description are to be regarded as illustrative in nature and not restrictive, and like reference numerals designate like elements throughout the specification.

In the description, unless explicitly stated to the contrary, the word “comprise” and variations such as “comprises” and “comprising” should be understood to imply the inclusion of stated elements but not the exclusion of any other elements.

In the description, reference numerals and names are attached for convenience of explanation, and the devices are not necessarily limited to the reference numerals or names.

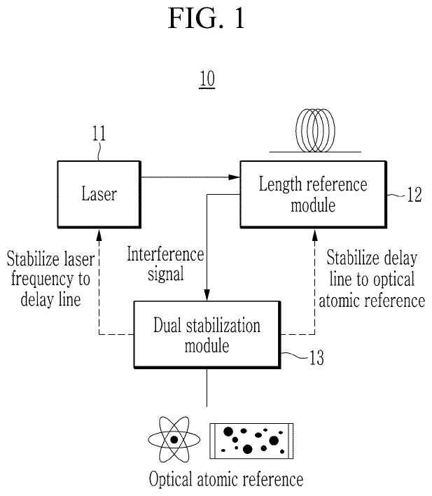

FIG. 1 conceptually illustrates a laser system of the present disclosure. Referring to FIG. 1, a laser system 10 stabilizes laser frequency to a length reference, and through this, a laser 11 emits frequency-stabilized light. Here, the laser system 10 of the present disclosure uses an optical atomic reference having excellent long-term stability to stabilize the length reference, and uses a length reference stabilized (locked) to the optical atomic reference to stabilize the laser frequency.

The laser system 10 may include a laser 11 serving as a stabilization target, an interferometer-type length reference module 12 including a length reference, and a dual stabilization module 13 configured to stabilize both the laser 110 and the length reference. The dual stabilization module 13 may be configured with a feedback loop to stabilize the laser frequency to the length reference based on an interference signal output from the length reference module 12, and another feedback loop to stabilize the length reference with respect to an optical atomic reference.

As optical atomic references, optical atomic clocks such as an ytterbium optical atomic clock, a rubidium optical atomic clock, and an atomic vapor cell may be employed. The type of optical atomic reference may be selected depending on the required level of laser frequency stability.

The length reference may be configured with a delay line, such as an optical fiber or an optical waveguide, and its length may be determined depending on the required level of laser frequency stability. Although an optical fiber delay line that is alignment-free and allows easy adjustment of the delay line length may be described, the present disclosure is not limited thereto, and any length reference operable according to the present disclosure may be selected. In the description, the terms “length reference” and “delay line” may be used interchangeably.

First, frequency stabilization based on length references will be described. Laser frequency noise is represented by frequency stability (df/f), which represents laser frequency fluctuation. Frequency error is detected using excellent length stability (dl/l) of the length reference, and the laser may be stabilized by receiving feedback on the frequency error. Representative length references include Fabry-Perot resonators, dielectric-based whispering gallery modes (WGMs), and delay lines that utilize the distance between two mirrors, and lasers stabilized to these length references have the advantage of good short-term stability. On the other hand, the long-term stability of the laser frequency stabilized to the length reference may degrade significantly due to length fluctuation caused by temperature changes. Therefore, in order to improve both the short-term and long-term stability of the laser frequency, a conventional method stabilize the laser frequency to the length reference and then additionally stabilize the laser frequency by comparing the laser frequency with the optical atomic reference. However, this approach is technically challenging because it requires stabilizing one laser frequency to two references, and the system becomes complex due to the need for an additional frequency modulator.

Unlike conventional frequency stabilization methods, the laser system 10 of the present disclosure performs laser frequency stabilization using the length reference, but stabilizes the length reference using an optical atomic reference having excellent long-term stability. As a result, the laser system 10 generates an accurate laser frequency with both excellent short-term stability and long-term stability. That is, by transferring the long-term stability of the optical atomic reference to the length stability, a highly accurate length reference with both excellent short-term stability and long-term stability may be achieved.

The length reference module 12 and a dual stabilization module 13 of the laser system 10 may be implemented in various ways, and some representative embodiments are described below.

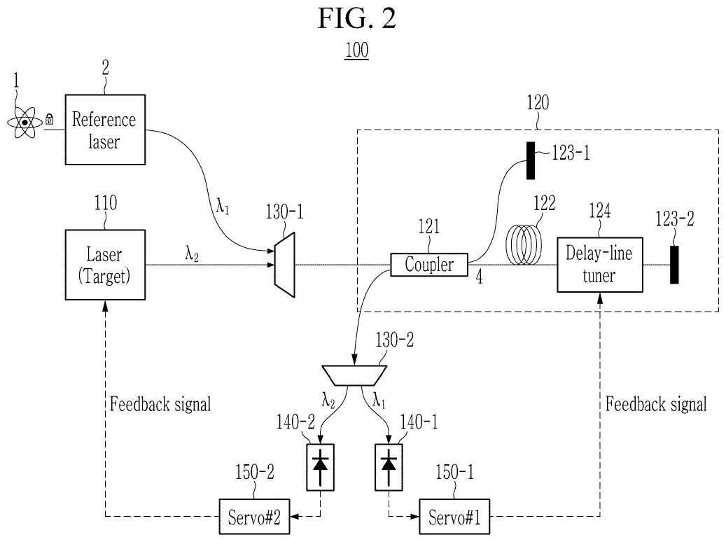

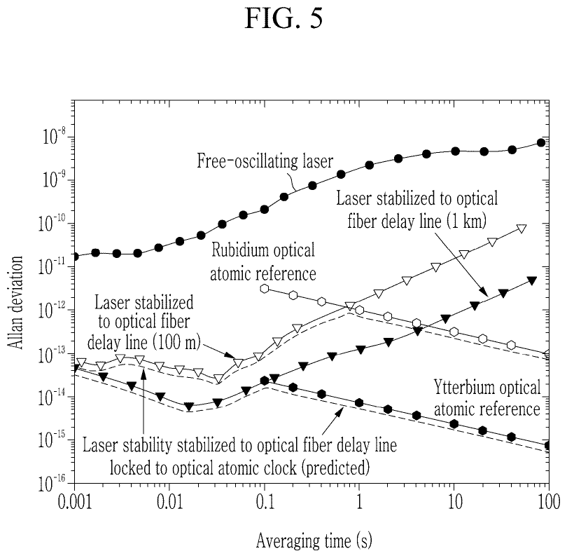

FIGS. 2 to 4 each illustrate the laser system according to an embodiment, and FIG. 5 illustrates laser frequency stability stabilized by the laser system according to an embodiment.

Referring to FIG. 2, a laser system 100 may stabilize the length reference using an optical signal stabilized to an optical atomic reference 1. The optical atomic reference 1 may be an optical atomic clock, an atomic vapor cell, or the like. Although an optical atomic clock is used as an example in the following description, the present disclosure does not preclude the use of references other than optical atomic clocks. An optical signal stabilized to the optical atom reference 1 may be referred to as a reference optical signal, and may be provided by a reference laser 2 stabilized to the optical atomic reference 1. The reference laser 2 may be a continuous-wave laser that emits light of a specific wavelength. The laser 110 to be stabilized may be referred to as a target laser, and the optical signal output from the target laser may be referred to as a target optical signal.

The laser system 100 may be configured to input optical signals of different wavelengths output from each of the reference laser 2 and a target laser 110 into a length reference module 120 of interferometer type, and to optically detect signals of different wavelengths separated from the interference signal output from the length reference module 120 and feed them back to the length reference module 120 and the laser 110. This enables the length reference to be locked to an optical atomic reference 1, and the laser 110 to be stabilized to the length reference locked to the optical atomic reference 1. In the present disclosure, photodetection of an optical signal may be performed in various ways. To distinguish and explain various photodetection methods in the following, as the terms “photodetection” and “balanced photodetection” may be used, but either balanced or general photodetection may be adopted depending on the need for decoupling of intensity noise.

The laser system 100 may independently process optical signals by multiplexing and dividing optical signals of different wavelengths. Therefore, the laser system 100 may simultaneously stabilize a plurality of target lasers by distinguishing them with different wavelengths. In addition, the laser system 100 may stabilize various types of target lasers, and thus may stabilize not only the continuous-wave laser that outputs a single-wavelength optical signal, but also a pulsed laser that outputs an optical frequency comb.

The laser system 100 may include the target laser 110, the interferometer-type length reference module 120, wavelength dividers 130-1 and 130-2, photodetectors 140-1 and 140-2, and servo systems 150-1 and 150-2. The laser system 100 receives the output of the reference laser 2 stabilized with respect to the optical atomic reference 1 to stabilize the length reference, and the reference laser 2 is configured to output an optical signal having a different wavelength from the target laser 110. The description assumes that a reference optical signal of wavelength λ₁ and a target optical signal of wavelength λ₂ are used. When additional target lasers are introduced, corresponding photodetectors and servo systems for detecting and providing feedback for the respective frequency errors may be added to the laser system 100.

A reference optical signal stabilized with respect to the optical atomic reference 1 and a target optical signal output from the target laser 110 may be combined by the wavelength divider 130-1 and input to the length reference module 120. The wavelength divider 130-1 may be implemented with a wavelength division multiplexer (WDM), a fiber Bragg grating (FBG), or the like.

The interferometer-type length reference module 120 includes a delay line that serves as a length reference, and may be configured to output an interference signal of two optical signals that have passed through a reference path and a delay path including the delay line. The length reference module 120 may be configured to compensate the fluctuation of the delay line with respect to the optical atomic reference 1 based on the feedback signal. This allows the length stability of the delay line to follow the stability of the optical atomic reference 1.

The length reference module 120 may be configured in a homodyne interferometer type that measures the change in light intensity caused by interference due to an optical-path difference between the reference path and the delay path. For illustrative purposes, a Michelson interferometer may be used as an example. However, the interferometer may be modified into various interferometers capable of stabilizing the length reference to the optical atomic reference in the method disclosed in the present disclosure.

For example, the length reference module 120 based on a Michelson interferometer may include a coupler 121 that divides or combines input light into a reference path and a delay path, a delay line 122 configuring the delay path, reflectors 123-1 and 123-2 connected to the ends of the reference path and the delay path, and a delay-line tuner 124.

The coupler 121 may be a 5:5 coupler dividing the input equally, and may be an unbalanced optical coupler. The delay line 122 may be configured with an optical fiber or an optical waveguide. The reflectors 123-1 and 123-2 may be conventional mirrors or a Faraday rotating mirrors (FRM). For example, when a single-mode non-polarization-maintaining fiber is used, the reflectors 123-1 and 123-2 may be may be the FRMs. When a polarization-maintaining fiber is used, the reflectors 123-1 and 123-2 may be conventional mirrors.

An optical signal incident on the coupler 121 is divided according to a coupling ratio (e.g., 5:5) and input to a reference path and a delay path including the delay line 122, and is reflected by the reflectors 123-1 and 123-2 and returns to the coupler 121 to cause interference.

The delay-line tuner 124 receives a feedback signal for compensating the fluctuation of the delay line from a servo system #1 150-1, and adjusts the length of the delay line or modulates the frequency so that the fluctuation of the delay line becomes zero based on the feedback signal. As a result, the length stability of the delay line follows the stability of the optical atomic reference 1. The delay-line tuner 124 is configured with a PZT stretcher or the like, enabling easy modulation of the delay line without degrading performance as a length reference.

The interference signal output from the length reference module 120 may be divided into a wavelength λ₁ component corresponding to the reference optical signal and a wavelength λ₂ component corresponding to the target laser by a wavelength divider 130-2. An interference signal of wavelength λ₁ may be input to a photodetector 140-1, and an interference signal of wavelength λ₂ may be input to a photodetector 140-2.

The photodetector 140-1 may detect an interference signal of wavelength λ₁ and output an error signal corresponding to the fluctuation of the delay line with respect to the optical atomic reference 1. The error signal may be input to the servo system #1 150-1.

The servo system #1 150-1 may generate a feedback signal for compensating the fluctuation of the delay line based on the error signal and transmit the feedback signal to the delay-line tuner 124 of the length reference module 120. Even if length changes occur due to temperature change, long-term stability may be improved because the delay line is locked to the optical atomic reference by the delay-line tuner 124. The length of the delay line also has an accurate value due to accurate frequency of the optical atomic reference 1. As a result, an accurate length reference with excellent short-term and long-term stability may be implemented.

Meanwhile, the photodetector 140-2 may detect an interference signal of wavelength λ₂ and output an error signal corresponding to the laser frequency fluctuation (laser frequency noise) with respect to the delay line length. The error signal may be input to a servo system #2 150-2. Because the delay line is stabilized to the optical atomic reference 1 through another feedback loop, the error signal detected by the photodetector 140-2 ultimately reflects the fluctuation of the laser frequency with respect to the length reference locked to the optical atomic reference 1.

The servo system #2 150-2 may generate a feedback signal for compensating for laser frequency fluctuation based on an error signal and transmit the feedback signal to a frequency modulator (not shown) of the laser 110. The length reference is locked to the optical atomic reference 1, and the laser 110 is stabilized by the length reference so that both short-term stability and long-term stability are excellent and an accurate frequency may be generated.

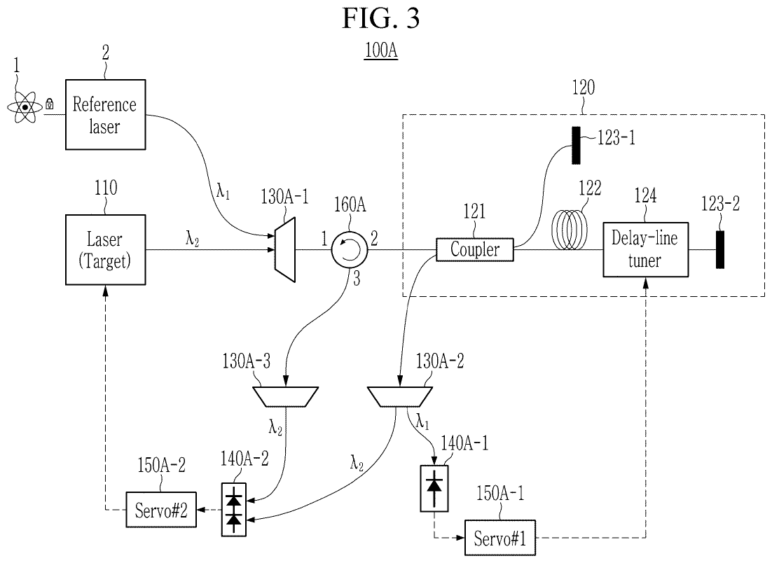

Referring to FIG. 3, the laser system 100 of FIG. 2 may perform balanced photodetection to offset laser intensity noise included in the interference signal.

A laser system 100A may include the target laser 110, the interferometer-type length reference module 120, wavelength dividers 130A-1, 130A-2, and 130A-3, a photodetector 140A-1, a balanced photodetector (BPD) 140A-2, servo systems 150A-1 and 150A-2, and a circulator 160A. In FIG. 3, detailed descriptions of components identical or similar to the laser system 100 are omitted. The photodetector 140A-1 may also implemented with a balanced photodetector in order to offset intensity noise included in the signal comparing the reference laser to the delay line. In this case, the wavelength λ₁ component corresponding to the reference optical signal may be additionally extracted from a wavelength divider 130A-3.

The reference optical signal stabilized to the optical atomic reference 1 and the target optical signal output from the target laser 110 are combined by the wavelength divider 130A-1 and may be input to the length reference module 120 through the circulator 160A.

The length reference module 120 includes a delay line serving as a length reference, and may be configured to output an interference signal of two optical signals that have passed through the reference path and the delay path of the delay line. The length reference module 120 may include the delay-line tuner 124 that compensates the fluctuation of the delay line with respect to the optical atomic reference 1 based on a feedback signal.

In the length reference module 120, the interference signal generated by interference between two optical signals is divided into two. A first interference signal is provided to the wavelength divider 130A-2, and a second interference signal may pass through the circulator 160A and be input to another wavelength divider 130A-3.

The first interference signal may be divided into the wavelength λ₁ component corresponding to the reference optical signal and the wavelength λ₂ component corresponding to the target laser by the wavelength divider 130A-2. An interference signal of wavelength λ₁ may be input to the photodetector 140A-1, and an interference signal of the wavelength λ₂ may be input to a first port of the balanced photodetector 140A-2.

The photodetector 140A-1 may detect an interference signal of the wavelength λ₁ and output an error signal corresponding to the fluctuation of the delay line with respect to the optical atomic reference 1. The error signal may be input to the servo system #1 150A-1. The servo system #1 150A-1 may generate a feedback signal for compensating fluctuation of the delay line based on the error signal and transmit the feedback signal to the delay-line tuner 124. The delay-line tuner 124 may adjust the length of the delay line or perform frequency modulation so that the fluctuation of the delay line becomes zero based on the feedback signal. As a result, the length stability of the delay line follows the stability of the optical atomic reference 1.

Meanwhile, the wavelength λ₂ component corresponding to the target laser is extracted from the second interference signal by the wavelength divider 130A-3 and may be input to a second port of the balanced photodetector 140A-2.

The balanced photodetector 140A-2 may detect a voltage signal for responding to the difference in intensity of signals input to two photodiodes using two photodiodes and a differential amplifier, and output an error signal corresponding to laser frequency fluctuation. The error signal may be input to the servo system #2 150A-2. The servo system #2 150-2 may generate a feedback signal for compensating for laser frequency fluctuation based on an error signal and transmit the feedback signal to a frequency modulator (not shown) of the laser 110.

The interference signal may include laser intensity fluctuation as well as laser frequency fluctuation. Therefore, by offsetting the laser intensity noise commonly included in the input lights through balanced photodetection that measures the intensity difference between the input lights, the laser intensity noise may be decoupled from the frequency noise. That is, the balanced photodetector 140A-2 may be used when it is necessary to prevent laser intensity noise from being coupled to frequency noise and measured.

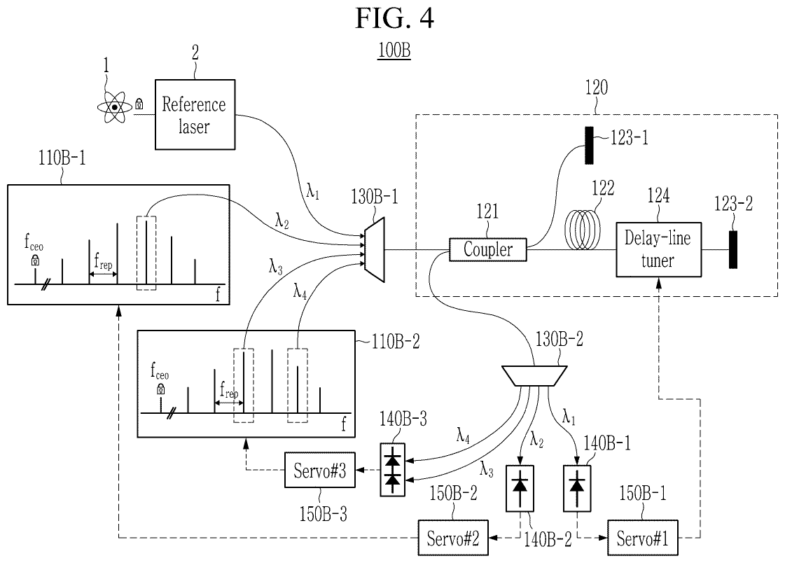

Referring to FIG. 4, the laser system 100 of FIG. 2 may stabilize not only a continuous-wave laser but also a pulsed laser that outputs an optical frequency comb. The optical frequency comb is represented in the frequency domain as a discontinuous spectrum with a constant frequency spacing (fᵣₑₚ). The frequency mode of the optical frequency comb, also referred to as a comb-line mode, is defined by the repetition rate (fᵣₑₚ) and the carrier envelope offset frequency (f_{ceo}). For frequency stabilization using one frequency mode, the frequency mode of the optical frequency comb may be mode-locked. A laser system 100B stabilizes the length reference to the optical atomic reference 1 by using a reference optical signal λ₁ stabilized to the optical atomic reference 1, like the laser system 100 of FIG. 2. At the same time, the laser system 100B may stabilize at least one pulsed laser 110B-1 and 110B-2 outputting an optical frequency comb to a length reference. To describe various frequency stabilization methods, it is assumed that the pulsed laser 110B-1 is stabilized to a length reference using a single frequency mode λ₂ of an optical frequency comb, and the pulsed laser 110B-2 is stabilized to a length reference using a frequency mode spacing (spacing of λ₃ and λ₄) of an optical frequency comb. The frequency mode (target optical signal) of the optical frequency comb used for frequency stabilization may be filtered using the wavelength division multiplexer (WDM), the fiber Bragg grating (FBG), or the like.

The reference optical signal λ₁ and a plurality of target optical signals λ₂, λ₃, and λ₄ are combined through a wavelength divider 130B-1 and then input to the length reference module 120.

The length reference module 120 includes a delay line serving as a length reference, and may be configured to output an interference signal of two optical signals that have passed through the reference path and the delay path of the delay line. The length reference module 120 may include the delay-line tuner 124 that compensates for the fluctuation of the delay line with respect to the optical atomic reference 1 based on a feedback signal.

The interference signal may be separated into wavelength components corresponding to the reference optical signal λ₁ and the plurality of target optical signals λ₂, λ₃, and λ₄ by a wavelength divider 130B-2.

A photodetector 140B-1 may detect an interference signal of the wavelength λ₁ and output an error signal corresponding to the fluctuation of the delay line with respect to the optical atomic reference 1. The error signal may be input to the servo system #1 150B-1. The servo system #1 150B-1 may generate a feedback signal for compensating for fluctuation of the delay line based on the error signal and transmit the feedback signal to the delay-line tuner 124. The delay-line tuner 124 may adjust the length of the delay line or perform frequency modulation so that the fluctuation of the delay line becomes 0 based on the feedback signal, thereby making the length stability of the delay line follow the stability of the optical atomic reference 1.

A photodetector 140B-2 may detect an interference signal of the wavelength λ₂ and output an error signal corresponding to the frequency fluctuation of the pulsed laser 110B-1 with respect to the delay line length. The error signal may be input to the servo system #2 150B-2. The servo system #2 150B-2 may generate a feedback signal for compensating for laser frequency fluctuation based on an error signal and transmit the feedback signal to a frequency modulator (not shown) of the pulsed laser 110B-1. With the carrier envelope offset frequency (f_{ceo}) locked, all modes may be stabilized as one mode is independently stabilized.

A photodetector 140B-3 may output an error signal corresponding to the fluctuation of the mode spacing (spacing between λ₃ and λ₄) of the pulsed laser 110B-2. The difference between the error signal corresponding to the interference signal at the wavelength λ₃ and the error signal corresponding to the interference signal at the wavelength λ₄ may indicate a spacing fluctuation between the two wavelengths. A servo system #3 150B-3 may generate a feedback signal for compensating for laser frequency fluctuation based on an error signal and transmit the feedback signal to a frequency modulator (not shown) of the pulsed laser 110B-2. With the carrier envelope offset frequency (f_{ceo}) locked, the spacing between the modes of the optical frequency comb may be stabilized as the specific mode spacing is stabilized.

FIG. 5 is the predicted stability diagram of a free-oscillating laser stabilized on an optical fiber delay line (100 m, 1 km) locked to an ytterbium optical atomic reference or a rubidium optical atomic reference, and stabilized on an optical fiber delay line locked to an optical atomic reference, in the laser system 100A with a balanced photodetector. A laser stabilized to the 1 km optical fiber delay line that is not locked to an optical atomic reference can be seen to diverge by length drift in the 0.01 to 0.1 second time domain. On the other hand, since the ytterbium optical atomic reference has a frequency stability of about 10-15 per second, a laser stabilized to an optical fiber delay line locked to the ytterbium optical atomic reference will follow the short-term stability of the optical fiber delay line and the long-term stability of the optical atomic reference. The optical atomic reference and the delay line length may be combined in various ways depending on the required level of laser stability.

On the other hand, the time at which the laser follows the length reference (delay line) and the optical atomic reference may be controlled according to the conditions of the two servos. For example, in FIG. 5, a laser stabilized by the optical fiber delay line (1 km) and a rubidium optical atomic reference follows the stability of the rubidium optical atomic reference from about 7 seconds, but by adjusting the conditions of the two servos to set the lock band to about 1 second, the laser may follow the stability of the rubidium optical atomic reference at an earlier time.

As such, according to the present disclosure, by stabilizing the length reference to the optical atomic reference and stabilizing the laser frequency to the stabilized length reference, a laser system having excellent and accurate short-term and long-term stability may be implemented.

According to the present disclosure, the delay line may be configured with an all-fiber delay line, providing excellent short-term and long-term stability for the laser frequency, allowing alignment-free operation and stable use even in environments outside the laboratory. Unlike conventional systems that are misaligned due to external shock or vibration, the present disclosure may operate without problems even in environments with vibration or shock as long as all components are coupled to optical fibers and the optical fibers are not damaged.

According to the present disclosure, since there is no restriction on the type of optical fiber required for the laser stabilization apparatus, the optimal optical fiber may be selected based on conditions such as cost and performance, thereby improving the price competitiveness of the laser stabilization apparatus while increasing design flexibility.

According to the present disclosure, since only a few passive optical components are required for frequency stabilization, the setup is simple and compact, which is advantageous for miniaturization and packaging. In particular, since all internal components operate passively during packaging, no additional thermal management is required, a sealed enclosure made of a material with low thermal conductivity may be used, and an optical fiber spool may also be miniaturized.

According to the present disclosure, the lasers to be stabilized may be independently stabilized on the delay line by distinguishing them in the wavelength domain based on the wide bandwidth of the delay line. In the past, an expensive optical frequency comb was required to extend the stability of a stable single-wavelength laser to other wavelengths, and this required the difficult task of f_{ceo} stabilization of the optical frequency comb. In fact, a difference frequency generation comb (DFG comb) has been developed capable of omitting the demanding f_{ceo} stabilization task, but its range of applications is inevitably limited due to its high price. In contrast, the present disclosure may achieve the same purpose at a relatively low cost by allowing the delay line stabilized to the optical atomic reference to replace the role of the DFG comb.

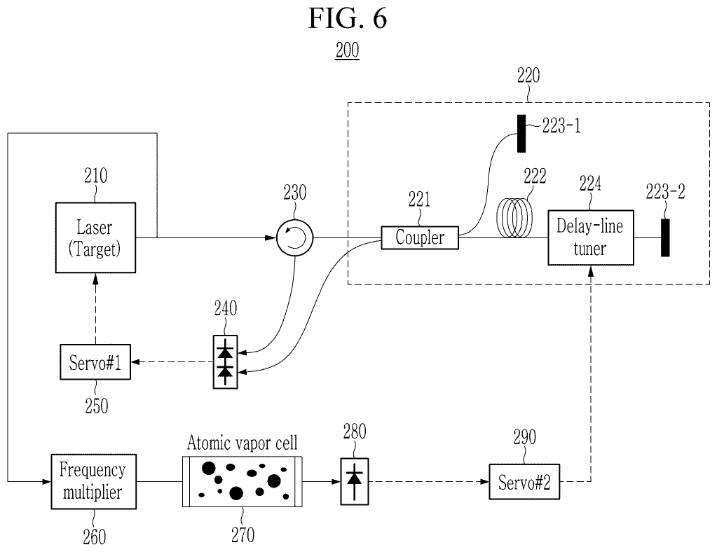

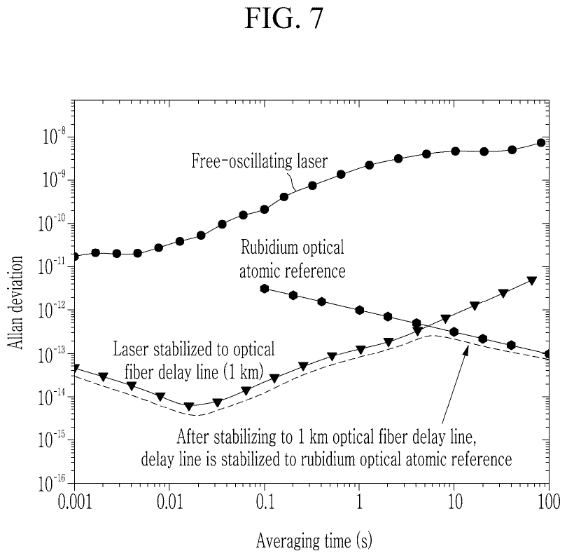

According to the present disclosure, the optical frequency comb may be directly stabilized using a single frequency mode filtered from the optical frequency comb without requiring stabilization of the optical frequency comb through the continuous-wave laser. FIG. 6 illustrates a laser system according to another embodiment, and FIG. 7 illustrates laser frequency stability stabilized by the laser system according to another embodiment.

Referring to FIG. 6, a laser system 200 may stabilize the length reference by using an atomic vapor cell 270 as an optical atomic reference.

While length references provide excellent short-term stability, they have the disadvantage of unstable long-term stability of the laser frequency due to length fluctuations caused by temperature changes. To improve this, the laser system 200 may stabilize the length reference by using an atomic vapor cell, which is simple to set up and cost-effective compared to optical atomic references with long-term stability. While optical atomic clock-based systems are complex and expensive and can only be built in large-scale laboratories at the national laboratory level, atomic vapor cells have the advantage of not requiring complex systems and may be built inexpensively.

The laser system 200 may operate based on two feedback loops: stabilizing a laser 210 to the length reference (delay line) and stabilizing (locking) the length reference to the atomic vapor cell 270. The linewidth indicating the short-term stability of the laser 210 is reduced by the length reference, and the long-term stability may be improved by compensating for the length variation of the length reference due to temperature change using the atomic vapor cell 270.

The laser system 200 may include the laser 210, an interferometer-type length reference module 220, a photodetector 240, a servo system #1 250, a frequency multiplier 260, the atomic vapor cell 270, a photodetector 280, and a servo system #2 290. To offset the laser intensity noise included in the interference signal, the photodetector 240 may be implemented with a balanced photodetector, and a circulator 230 may be added for this purpose.

The length reference module 220 may be configured in a homodyne interferometer type, like the length reference module 120. The length reference module 220 includes a delay line serving as a length reference, and may be configured to output an interference signal of two optical signals that have passed through the reference path and the delay path of the delay line. The length reference module 220 may be configured to compensate for the fluctuation of the delay line based on the feedback signal. For example, the length reference module 220 based on a Michelson interferometer may include a coupler 221 that divides or combines input light into a reference path and a delay path, a delay line 222 that configures a delay path, reflectors 223-1 and 223-2 connected to the ends of the reference path and the delay path, and a delay-line tuner 224. The delay-line tuner 224 may adjust the length of the delay line or perform frequency modulation, thereby ensuring that the length stability of the delay line follows the stability of the atomic vapor cell 270. The delay-line tuner 224 may be configured with a PZT stretcher or the like.

The photodetector 240 may detect an interference signal and output an error signal corresponding to the laser frequency fluctuation (laser frequency noise) for the delay line length. The error signal may be input to the servo system #1 250. The servo system #1 250 may generate a feedback signal for compensating for laser frequency fluctuation based on an error signal and transmit the feedback signal to a frequency modulator (not shown) of the laser 210.

The laser frequency stabilized to the length reference is multiplied to a frequency suitable for interaction with the atomic vapor cell 270 through the frequency multiplier 260. The frequency multiplier 260 may be configured based on, for example, second harmonic generation (SHG).

The frequency-multiplied optical signal is input to the atomic vapor cell 270, and the optical signal that has passed through the atomic vapor cell 270 is detected by the photodetector 240. The photodetector 240 may output an error signal in which the absorption spectrum (frequency reference) of the atomic vapor cell 270 and the laser frequency are compared. The error signal may be post-processed in a specified manner and input to the servo system #2 290. The error signal is a signal comparing the absorption spectrum of the atomic vapor cell 270 and the laser frequency, but since the laser frequency stabilized to the delay line reflects the variation in the length of the delay line, it is ultimately a comparison of the absorption spectrum of the atomic vapor cell 270 and the delay line length.

The servo system #2 290 may generate a feedback signal for compensating for the fluctuation (length variation) of the delay line based on the error signal and transmit the feedback signal to a delay-line tuner 234 of the length reference module 220. By compensating for the fluctuation of the delay line by the delay-line tuner 234, the long-term stability of the length reference may be improved.

FIG. 7 is a predicted stability diagram of a free-oscillating laser stabilized by the laser system 200 including a rubidium optical atomic vapor cell and a 1 km optical fiber delay line with a frequency stability of about 10-12 per second.

A laser stabilized to the 1 km optical fiber delay line that is not locked to an optical atomic reference can be seen to diverge by length drift in the 0.01 to 0.1 second time domain. On the other hand, since a rubidium atomic vapor cell has a frequency stability of about 10-12 per second, a laser stabilized using an optical fiber delay line and the rubidium atomic vapor cell follows the short-term stability of the optical fiber delay line and the long-term stability of the rubidium atomic vapor cell.

On the other hand, as described in FIG. 5, the time at which the laser follows the length reference (delay line) and the optical atomic reference may be controlled according to the conditions of the two servos. For example, a laser stabilized by the optical fiber delay line (1 km) and the rubidium optical atomic reference follows the stability of the rubidium optical atomic reference from about 7 seconds, but by adjusting the conditions of the two servos to set the lock band to about 1 second, the laser may follow the stability of the rubidium optical atomic reference at an earlier time.

As such, according to the present disclosure, by stabilizing the length reference to the optical atomic reference and stabilizing the laser frequency to the stabilized length reference, it is possible to implement a laser system having excellent and accurate short-term and long-term stability.

The present disclosure provides a laser system with excellent long-term stability and accuracy even in a general laboratory using a simple and inexpensive atomic vapor cell as an optical atomic reference. According to the present disclosure, the delay line may be configured with an all-fiber delay line, providing excellent short-term and long-term stability for the laser frequency, allowing alignment freedom and stable use even in environments outside the laboratory. Coupling to a frequency multiplier or atomic vapor cell requires an alignment system that utilizes free space, but because of its small volume, multiple layers of shielding may protect the system from external shock or vibration.

According to the present disclosure, since there is no limitation on the type of optical fiber required for the laser stabilization apparatus, the optimal optical fiber may be selected based on conditions such as cost and performance, thereby increasing the price competitiveness of the laser stabilization apparatus while increasing design flexibility.

The present disclosure is simple to set up due to its overall small number of active components, and is easy to package because it is mostly optical fibers.

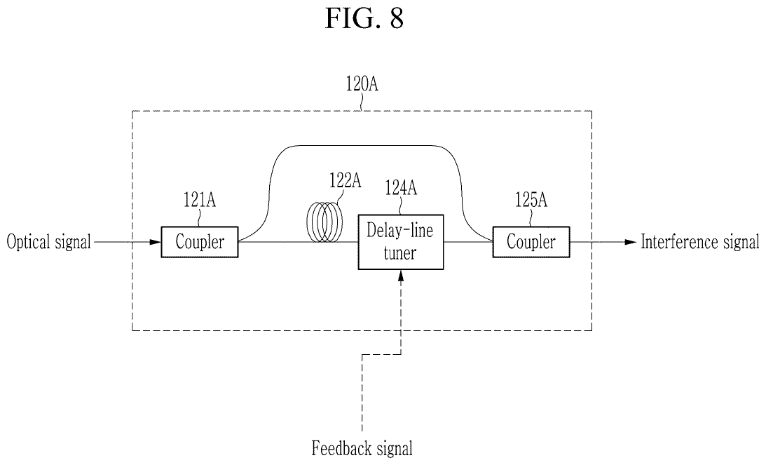

FIG. 8 illustrates a length reference module in the form of a Mach-Zehnder interferometer according to an embodiment.

Referring to FIG. 8, a length reference module 120A may be configured in the form of a Mach-Zehnder interferometer.

The length reference module 120A may include a first coupler 121A that divides input light into a reference path and a delay path, a delay line 122A that configures the delay path, a second coupler 125A that combines two optical signals that have passed through the reference path and the delay path, and a delay-line tuner 124A.

The optical signal is divided into the reference path and the delay path through the first coupler 121A and output, and the two optical signals that have passed through the reference path and the delay path are input to a second coupler 123A and interference occurs. The second coupler 123A may output an interference signal. The delay-line tuner 124A may adjust the length of the delay line or modulate the frequency to ensure that the length stability of the delay line follows the stability of the optical atomic reference.

The embodiments of the present disclosure described above are not implemented only through devices and methods, but may also be implemented through a program that realizes a function corresponding to the configuration of the embodiments of the present disclosure or a recording medium on which the program is recorded.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. A laser system comprising:
a laser;
an interferometer-type length reference module including a delay line, the length reference module being configured to receive an optical signal including output of the laser and output an interference signal; and
a dual stabilization module configured to stabilize a frequency of the laser to the delay line based on the interference signal and to stabilize the delay line to an optical atomic reference.

2. The laser system of claim 1, wherein the optical atomic reference comprises an optical atomic clock.

3. The laser system of claim 2, wherein the length reference module is configured to:
receive an optical signal in which a reference optical signal stabilized to the optical atomic clock and a target optical signal output from the laser are combined; and
output the interference signal generated by interference between two optical signals that have passed through a reference path and a delay path including the delay line, and
wherein the dual stabilization module is configured to:
stabilize the delay line using a first interference signal corresponding to a wavelength of the reference optical signal in the interference signal, and
stabilize the frequency of the laser using a second interference signal corresponding to a wavelength of the target optical signal in the interference signal.

4. The laser system of claim 1, wherein the optical atomic reference comprises an atomic vapor cell.

5. The laser system of claim 4, wherein the length reference module is configured to:
receive an optical signal output from the laser; and
output the interference signal generated by interference between two optical signals that have passed through a reference path and a delay path including the delay line, and
wherein the dual stabilization module is configured to:
stabilize the frequency of the laser using the interference signal; and
stabilize the delay line using an optical signal that is output from the laser, incident on the atomic vapor cell, and passed through the atomic vapor cell.

6. The laser system of claim 1, wherein the length reference module is configured in a Michelson interferometer type or a Mach-Zehnder interferometer type.

7. A laser system, comprising:
a length reference module configured to receive an optical signal in which a reference optical signal stabilized to an optical atomic reference and at least one target optical signal output from at least one target laser to be stabilized are combined, and output an interference signal generated by interference between two optical signals that have passed through a reference path and a delay path including a delay line;
a wavelength divider configured to separate a first interference signal corresponding to a wavelength of the reference optical signal and at least one second interference signal corresponding to a wavelength of the at least one target optical signal in the interference signal;
a first servo system configured to generate a first feedback signal for compensating fluctuation of the delay line with respect to the optical atomic reference based on a first error signal obtained through photodetection for the first interference signal, and transmit the first feedback signal to the length reference module; and
a second servo system configured to generate a second feedback signal for compensating frequency fluctuation of the corresponding target laser with respect to the delay line based on a second error signal obtained through photodetection for the second interference signal, and transmit the second feedback signal to the corresponding target laser.

8. The laser system of claim 7, wherein the length reference module comprises a delay-line tuner configured to adjust a length of the delay line or perform frequency modulation based on the first feedback signal.

9. The laser system of claim 7, wherein the reference optical signal and the at least one target optical signal are signals of different wavelengths.

10. The laser system of claim 7, wherein the target laser comprises a continuous-wave laser or a pulsed laser outputting an optical frequency comb.

11. The laser system of claim 10, wherein the target optical signal comprises a single wavelength optical signal output from the continuous-wave laser, one frequency mode filtered from the optical frequency comb, or two frequency modes filtered from the optical frequency comb.

12. The laser system of claim 7, wherein the optical atomic reference comprises an optical atomic clock.

13. A laser system, comprising:
a length reference module configured to receive an optical signal output from a laser and output an interference signal generated by interference between two optical signals that have passed through a reference path and a delay path including a delay line;
a first servo system configured to generate a first feedback signal for compensating frequency fluctuation of the laser with respect to the delay line based on a first error signal obtained through photodetection for the interference signal, and transmit the first feedback signal to the laser;
an atomic vapor cell through which the optical signal output from the laser passes; and
a second servo system configured to generate a second feedback signal for compensating fluctuation of the delay line with respect to the atomic vapor cell based on a second error signal obtained through photodetection for the optical signal that has passed through the atomic vapor cell, and transmit the second feedback signal to the length reference module.

14. The laser system of claim 13, further comprising
a frequency multiplier configured to multiply a frequency of the optical signal output from the laser to match a frequency of the atomic vapor cell, and emit the frequency-multiplied optical signal into the atomic vapor cell.

15. The laser system of claim 13, wherein the length reference module comprises
a delay-line tuner configured to adjust a length of the delay line or perform frequency modulation based on the first feedback signal.
